(19) United States
(12) Patent Application Publication
(10) Pub. No.: US 2025/0180436 A1
(43) Pub. Date: Jun. 5, 2025

(54) METHOD FOR MONITORING THE ENGINE SPEED OF AN AIRCRAFT

(71) Applicants: INSTITUT NATIONAL DES SCIENCES APPLIQUÉES LYON :, Villeurbanne Cedex (FR); SAFRAN, PARIS (FR)

(72) Inventors: Yasmine HAWWARI, MOISSY CRAMAYEL (FR); Dany ABBOUD, MOISSY CRAMAYEL (FR); Yosra MARNISSI, MOISSY CRAMAYEL (FR); Mohammed EL BADAOUI, MOISSY CRAMAYEL (FR); Jérôme ANTONI, VILLEURBANNE CEDEX (FR); Hugo ANDRE, VILLEURBANNE CEDEX (FR)

(21) Appl. No.: 18/851,560

(22) PCT Filed: Mar. 27, 2023
(86) PCT No.: PCT/FR2023/050430

§ 371 Date: Sep. 26, 2024

(30) Foreign Application Priority Data
Mar. 28, 2022 (FR) FR2202763

(51) Int. Cl. G01M 15/14; G01H 1/00

(52) U.S. Cl. CPC G01M 15/14; G01H 1/003

(57) ABSTRACT

A method for monitoring the engine speed of a rotating machine, includes constructing a raw spectrogram from a vibratory signal; denoising the spectrogram to obtain an equalised spectrogram, the denoising including a first sub-procedure of determining a foot of the spectrogram, the foot of the spectrum being a set of random harmonic components contained in the raw spectrogram, the first sub-procedure including a first sub-sub-procedure of constructing a regression function robust to the peaks of the spectrogram, the regression function being applied to a logarithm of the spectrogram or to the spectrogram; a second sub-sub-procedure of determining the foot of the spectrum from the regression function; a second sub-procedure of determining the equalised spectrogram from the foot of the spectrogram; separating sources in the equalised spectrogram by determining an estimator of the frequencies of interest; determining an instantaneous speed of rotation of the engine speed from the estimator.

### TECHNICAL FIELD OF THE INVENTION

The technical field of the invention is that of monitoring rotating machine and more particularly aircraft engines by analysing vibratory signals, and engine power transmission.

This invention relates to a method for monitoring the engine speed of a rotating machine.

### Technological Background of the Invention

There are a number of methods for monitoring rotating machines, especially by measuring vibration induced by the operation of the machine and the driven elements. However, methods known to the state of the art in this field are difficult to apply to aeronautical machines, in particular aircraft and helicopter engines. Indeed, monitoring the operation of aircraft engines is made difficult, on the one hand, by the accessibility and overall size of shaft lines and rotating engines in critical environments, which hampers installation for dedicated monitoring devices and systems, and, on the other hand, by the fact that the engine speeds of these rotating machines are very high, which causes additional harmonics to appear in the vibratory signal, unlike an engine with a low-speed operating regime, which will have a vibratory signal whose spectrum is less rich in harmonics. These additional frequencies then risk interfering with and masking the frequencies of interest for evaluating operating state of the engine. This is known as harmonic interference.

Furthermore, as aircraft engines are designed to reach very high speeds of rotation, they are subject to very high acceleration and deceleration phases. Vibratory signals acquired during these phases are therefore non-stationary and have a strong variability. In addition, the different parts of the engine will not behave in the same way during an acceleration or deceleration phase. Harmonic interference is therefore dependent on the operating mode of the engine.

Furthermore, aircraft engines can be arranged in several parts which do not necessarily have synchronous operating modes. In general, turbomachines include two rotation shafts, each with a different speed of rotation. In this case the speeds of rotation N1 and N2 of the shafts are referred to. It is also possible for the different parts, especially the shafts of the speeds N1 and N2, to have asynchronous operating modes during stationary phases of engine speed, as well as during acceleration and deceleration phases. These asynchronous operating modes can also generate additional harmonic content which is detrimental to the discrimination of multiple frequencies associated with the operation of the different rotating elements of the engine in the signal spectrum. Indeed, some harmonic components will overlap or mask each other, resulting in a poor estimation of the operating state of the engine. Harmonic interference is also dependent on the operating modes of the different parts of the engine, which may not be synchronised and whose speed of rotation may vary greatly over time.

Finally, when an aircraft engine is in operation, there are many sources of noise, from solid, airborne or thermal sources. The main sources of noise are the combustion of fuel to move the aircraft, the aerodynamic flow of fluids in the engine and around the apparatus and the resonance of different elements in the engine and the aircraft due to vibration generated by the engine. These multiple sources of noise, most of which are broadband, mean that the signal-to-noise ratio levels in the acquired vibratory signals are low and it is difficult to differentiate the frequency content of interest therein, which is representative of the operating state of the engine, from the noise.

The vast majority of state-of-the-art monitoring methods rely on the use of a speed or angular position signal (for example, patents and applications FR3087265A1, WO2019207242A1, FR3102858A1, FR3096133B1, FR3079977B1) to measure reference vibratory signals. For these methods, it is therefore necessary to measure this speed of rotation, which also forces to add hardware instrumentation to the monitoring system. However, in aeronautics, the number of sensors that can be installed is very restricted. Installation of a position sensor, whose resolution is often too low in relation to the signals measured, is moreover very difficult, if not impossible, due to the overall size and need for compactness of engine systems. Furthermore, the speed or angular position sensors commonly used are not very well adapted for use in aircraft engines, as they are not very robust to the critical conditions in which engines operate (very strong vibration, high temperature and pressure gradients, high speeds, etc.).

Furthermore, methods for single-frequency analysis of vibratory signals, from which the instantaneous speed of rotation is estimated are known from the state of the art. This speed is determined by applying a bandpass filter around a single component of the signals. However, these methods are not compatible with an aeronautical application due to the harmonic interference described above, the multiplicity of harmonics of interest present in such a vibratory signal and the high noise levels measured.

Estimation methods are also known, based on comparison with a reference vibratory signal or applied to simple structures where the harmonic content is readily identifiable, because the operating regimes are low speed and the variations are slow or stepwise. These methods are not compatible for aeronautical applications, since the rotating elements of aircraft are subject to sudden transient regimes, specific to each element, and to operating regimes with very high speeds, generating very rich harmonic content. In addition, under non-stationary regime, aircraft engines generate considerable spectral leakage in the spectra of vibratory signals measured, making it impossible to identify peaks by comparison with a reference signal. In the spectra, the spectral leakage results especially in the spreading of the frequency content and the appearance of parasitic harmonics.

Finally, there are known methods for the temporal analysis of vibratory signals. The drawback of these methods is that, in the time domain, the noise is highly correlated with the signals of interest, which means that all the harmonics have to be taken into account during analysis. In the case of an aeronautical signal, it is impossible to know all the harmonic components of the signals due to the complexity of the machine and the multiplicity of the operating modes of the engines. In addition, a harmonic may lose amplitude locally and be masked by high noise levels or harmonic interference. Furthermore, in these methods, the noise is modelled with a Gaussian behaviour, which is not realistic in an aeronautical case where the noise is impulsive in nature.

There is therefore a need for a method for monitoring the operating state of a rotating machine, by means of a vibratory signal, for discriminating the harmonic content of interest from the noise generated by the operation of the machine and reducing sensitivity of the vibratory signal to harmonic interference.

### SUMMARY OF THE INVENTION

The invention offers a solution to the problems previously discussed, by enabling monitoring, by virtue of the measurement of a vibratory signal, of a rotating machine so that the harmonic content of interest is discriminated from the noise generated by the operation of the machine, while reducing sensitivity of the vibratory signal to harmonic interference.

A first aspect of the invention relates to a method for monitoring the engine speed of a rotating machine, the method comprising the following steps of:
Constructing a raw spectrogram from a vibratory signal measured by a vibration sensor;
Denoising the raw spectrogram to obtain an equalised spectrogram, the denoising step comprising:
   A first sub-step of determining a foot of the raw spectrogram, the first sub-step comprising:
      A first sub-sub-step of constructing a regression function robust to the peaks of the raw spectrogram;
      A second sub-sub-step of determining the foot of the spectrum from the regression function;
   A second sub-step of determining the equalised spectrogram from the foot of the spectrogram;
Separating sources in the equalised spectrogram by determining an estimator of the frequencies of interest;
Determining an instantaneous speed of rotation of the engine speed from the estimator of the frequencies of interest.

By “rotating machine”, it is meant an engine machine whose engine transforms energy supplied to the engine into a rotational movement, for example through a shaft line. In the context of the invention, this refers especially to aircraft such as aeroplanes or helicopters, but it can also refer to wind turbine engines, engines of wheeled vehicles, etc.

By “engine speed monitoring”, it is meant monitoring of the operating state of the engine enabling the rotating machine to rotate, especially by estimating the instantaneous rotation of the rotating machine. Monitoring then makes it possible to anticipate and/or detect malfunctions in the operation of the rotating machine. For example, by estimating the instantaneous speed of rotation, it is possible to check whether the engine speed of the rotating machine is indeed that expected, in comparison with reference data, with a view to any maintenance of the rotating machine or detection of an operating anomaly. The instantaneous speed of rotation can be defined as the estimated speed of rotation in a time interval whose duration is shorter than the duration of the acquisition of the vibratory signal.

By “spectrogram”, it is meant the representation over time of the frequency content of one or more signals. Furthermore, the terms frequency content, harmonic content, harmonic components and harmonics all refer to the set of frequencies (or harmonics) contained in the spectrum of signals, the spectrum of a signal being obtained by applying a Fourier transform from the time domain to the frequency domain. The “harmonic content of interest” is thus the frequency content which represents the engine speed of the rotating machine and which makes it possible, especially, to determine its instantaneous speed of rotation, the frequencies of interest being linearly dependent on the instantaneous speed of rotation.

By “vibration sensor”, it is meant a sensor adapted to measure vibration to which a structure is subjected. It may, for example, be an accelerometer-type sensor based on the piezoelectric effect, a laser vibrometer, a capacitive or eddy current displacement sensor, etc.

By “harmonic interference”, it is meant the phenomenon whereby two frequency contents from different sources and simultaneously measured by the same sensor can partially or totally interfere with each other. This interference has the effect of partially or totally impairing the frequency content of the signal, especially by superimposing (in phase) or masking (in phase opposition) the harmonic content.

By virtue of the invention, it is possible to monitor engine speed of a rotating machine and determine its instantaneous speed of rotation by means of a highly noisy vibratory signal whose harmonic content of interest is impaired by harmonic interference. The method is therefore particularly adapted to high-speed applications such as helicopter and aeroplane engines in aeronautics. The method can also be applied to other types of rotating machines or combustion and explosion machines.

Implementing the monitoring method in the frequency domain makes it possible to speed up signal denoising and source separation processing, unlike an application in the time domain. In addition, in the frequency domain, the hypothesis that the noise is decorrelated from the signal is more realistic than in the time domain, making denoising easier and less biased.

The step of denoising the raw spectrogram of the vibratory signal thus makes it possible to obtain an equalised spectrogram, by virtue of using the foot of the spectrogram which is representative of the broadband noise, so as to have uniform noise levels at all points on the time and frequency axes. In addition, the foot of the spectrogram makes the spectrogram robust to the peaks present in its spectrum.

The step of determining an estimator of the frequencies of interest then makes it possible to reduce effects of harmonic interference in the equalised spectrogram, by separating sources in the vibratory signal, in order to better discriminate the frequencies of interest for determining the instantaneous speed of rotation of the rotating machine.

Finally, the method is easily practicable within the scope of an aeronautical application since it requires, at the very least, a single vibration sensor, the dimensions of which are compatible with the overall size and compactness issues of aeronautical systems. The method according to the invention therefore requires only a small amount of equipment to be installed in order to be operational. Furthermore, as vibration sensors are more robust in critical environments and more sensitive to high frequencies than speed or position sensors, the method is adapted to an aeronautical application.

Further to the characteristics just discussed in the previous paragraph, the method according to the first aspect of the invention may have one or more additional characteristics from among the following, considered individually or according to any technically possible combinations.

According to one alternative embodiment, the method further comprises a step of detecting an operating anomaly of the engine of the rotating machine as a function of the instantaneous speed of rotation.

By virtue of this alternative, it is possible to detect abnormal operation of one or more rotating elements in the shaft line of the rotating machine engine. By abnormal operation, it is meant an operating state of the engine speed which is not that expected for the engine speed in question, in relation to a nominal or reference operating state.

According to one alternative embodiment, the raw spectrogram is constructed by a Fourier Transform applied to the vibratory signal over a plurality of successive time windows of short duration.

By virtue of this alternative, it is possible to construct a spectrogram in time sections, so that the time interval over which the Fourier Transform is applied is sufficiently small for the hypothesis of a stationary signal to be valid.

According to one alternative embodiment, the source separation step is repeated until a convergence criterion is satisfied, said source separation step comprising a first sub-step of determining frequencies of interest as a function of amplitudes of the frequencies of interest, and a second sub-step of estimating amplitudes of the frequencies of interest as a function of the frequencies of interest, said first and second sub-steps being alternately performed at each iteration of said source separation step, and the estimator of the frequencies of interest being further determined as a function of the frequencies of interest and the amplitudes of the frequencies of interest.

By virtue of this alternative, it is possible to determine the estimator of the frequencies of interest when amplitudes of the frequencies of interest are not initially known. The iterative search by alternative estimation of the frequencies of interest and the associated amplitudes makes it possible to correct the frequency content of interest of the harmonic interference. This correction is also made adaptively by alternately implementing the steps of estimating the frequencies of interest and estimating the associated amplitudes. The adaptive nature of this alternative means that the method is robust to variations in aircraft engine speed. The method is therefore suitable for estimating the instantaneous speed of rotation even when the vibratory signal is non-stationary.

According to one alternative embodiment, the source separation step is implemented by an Expectation-Maximisation algorithm, where the first sub-step of determining frequencies of interest is the E-step of the Expectation-Maximisation algorithm, and where the second sub-step for estimating amplitudes of the frequencies of interest is the M-step of the Expectation-Maximisation algorithm.

According to one alternative embodiment, the sub-step of determining frequencies of interest as a function of amplitudes of the frequencies of interest comprises a first sub-sub-step of determining an a posteriori probability on the frequencies of interest, and a second sub-sub-step of determining an expectation of a log-likelihood of the amplitudes of the frequencies of interest.

According to one alternative embodiment, the sub-step of estimating the amplitudes of the frequencies of interest as a function of the frequencies of interest comprises a first sub-sub-step of determining an a posteriori probability on the amplitudes of the frequencies of interest, a second sub-sub-step of determining an a posteriori probability on the amplitudes of the frequencies of interest, and a third sub-sub-step of determining a variance of a smoothed generalised Gaussian distribution of the equalised spectrogram.

According to one alternative embodiment, the estimator of the frequencies of interest is determined, as a stopping criterion is satisfied, as a function of the a posteriori probability on the frequencies of interest.

According to one alternative embodiment, the method further comprises a step of interpolating the estimator of the frequencies of interest.

According to one alternative embodiment, the method further comprises a step of smoothing interpolation of the estimator of the frequencies of interest.

A second aspect of the invention relates to a computer program product comprising instructions which, when the program is executed on a computer, cause the same to implement the steps of the method according to the first aspect of the invention.

A third aspect of the invention relates to a computer-readable recording medium comprising instructions which, when executed by a computer, cause the same to implement the steps of the method according to the first aspect of the invention.

The invention and its different applications will be better understood upon reading the following description and upon examining the accompanying figures.

### BRIEF DESCRIPTION OF THE FIGURES

The figures are set forth byway of indicating and in no way limiting purposes of the invention.

FIG. 1 is a block diagram illustrating the sequence of steps of the method according to the invention.

FIG. 2 shows two examples of spectrograms constructed and processed by the method according to the invention for signals acquired from an aeroplane engine and a helicopter engine in operation.

FIG. 3 shows the raw spectrograms, i.e. not processed using the method according to the invention, from which originate the processed spectrograms of FIG. 2.

FIG. 4 illustrates the denoising method according to the invention for the spectrum of a vibratory signal.

FIG. 5 shows equalised spectrograms obtained after equalisation of the raw spectrograms of FIG. 3 following the denoising step of the method according to the invention.

FIG. 6 shows examples of a posteriori probabilities of the frequencies of interest determined according to the source separation step of the method according to the invention, for the equalised spectrograms of FIG. 5.

### DETAILED DESCRIPTION

Unless otherwise specified, a same element appearing in different figures has a single reference.

A first aspect of the invention relates to a method for determining the engine speed of a rotating machine. The method comprises four main successive steps.

The rotating machine is, for example, an aircraft engine including one or more shaft lines enabling the energy consumed by the engine to be transformed into rotational movement. The shaft line may include several elements, for example wheels and vanes, to enable the aircraft to be displaced.

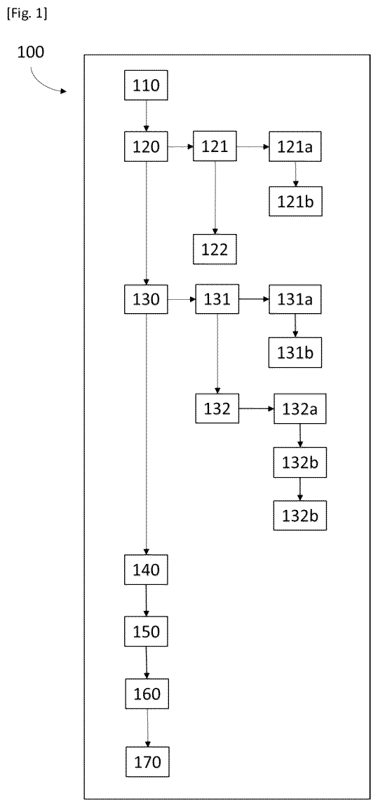

FIG. 1 shows a schematic representation of the main steps of the method 100 according to the invention.

The method 100 according to the invention includes a first step 110 of constructing a spectrogram. The spectrogram is a time-frequency representation of the harmonic content of an acquired signal. Preferably, this is a vibratory signal.

The vibratory signal is acquired by means of a vibration sensor, for example a piezoelectric accelerometer. The sensor is furthermore, for example, placed on a shaft line of the rotating machine or in proximity to said shaft line.

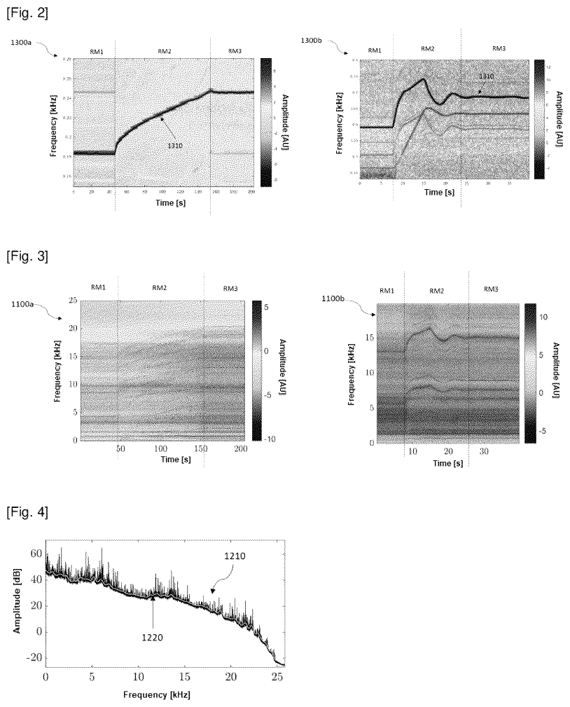

Two examples of spectrograms are provided in FIG. 2 for signals acquired, respectively, from an aeroplane engine and a helicopter engine in operation.

The x-axis of the spectrograms in FIG. 2 represents time, the y-axis represents frequency, whereas the grey scale represents the amplitude associated with each frequency.

The spectrogram represents the time evolution of the frequency content of the measured vibratory signal. Furthermore, the harmonic content of the spectrogram is representative of the state of the engine speed. Indeed, depending on the operating state of the engine, the harmonic content differs as a result of the excitation and resonance of the elements in the shaft line according to the natural modes of these elements. It is also known that the frequency content of the vibratory signal is linearly dependent on the engine speed of the rotating machine due to the periodicity of the engine rotation. This periodicity is moreover found in the harmonic content of the spectrum. Thus, the evolution of the harmonics and their amplitude over time in the vibratory signal provides direct information about the engine speed of the aircraft engine. In this case, the term trajectory in the time-frequency plane is used to refer to the evolution of one or more frequencies which are linearly dependent on the engine speed. In particular, these frequencies are dependent on the instantaneous speed of rotation of the engine. For the sake of generality, the instantaneous speed of rotation of the engine is also referred to as the instantaneous frequency, since they are linearly dependent on each other.

In FIG. 2, the spectrograms 1300a and 1300b have already been processed by the method 100 according to the invention following the steps which will be described later, in order to better illustrate the point about the trajectory in the time-frequency plane and to support the interest of the invention compared with the state of the art. It can be observed from the processed spectrograms 1300a and 1300b that the evolution of a trajectory 1310, in the time-frequency plane, of the highest amplitude harmonic is linearly dependent on the variation in the instantaneous speed of rotation of the aeroplane engine. It is noticed that this trajectory 1310 is initially stationary during a first stationary phase of the engine speed RM1, then during a second, longer phase of acceleration of the engine speed RM2, the trajectory 1310 changes and has its frequency increasing until it becomes stationary again upon reaching a third stationary phase of the engine speed RM3.

In a raw spectrogram, i.e. one that has not been processed using the method 100 according to the invention, tracking the trajectory 1310 is made difficult by the high noise levels and harmonic interference. This issue is illustrated in FIG. 3, where raw spectrograms 1100a and 1100b, derived from the vibratory signals previously mentioned, and associated with the processed spectrograms 1300a and 1300b of FIG. 2, are set forth. On these raw spectrograms 1100a and 1100b, the harmonic content of interest is masked by broadband noise, the level of which is similar to that at the frequencies of interest. In addition, it is difficult to discern the frequency or frequencies, often a few peaks related to the rotation of the shaft line, which are representative of the engine speed because the harmonic interference does not allow the frequencies of interest to be identified, by their amplitude, from the frequencies related to noise (of solid or airborne origin whose source is not directly the engine of the rotating machine). Furthermore, depending on the engine speed, the noise may also contain harmonic content originating from resonance of the different elements making up the aircraft due to the excitation of the natural modes of these elements.

Furthermore, it can be clearly noticed from the spectrograms in FIG. 3 that the phenomenon of harmonic interference is dependent on engine speed. The harmonic content of the raw spectrograms 1100a and 1100b is, in fact, very different between engine speeds RM1 to RM3. Upon reading together the processed spectrograms 1300a and 1300b and the raw spectrograms 1100a and 1100b, in FIGS. 2 and 3 respectively, it is thus possible to understand the advantage of the method 100 according to the invention.

A raw spectrogram 1100, during the first step 110, can be obtained by a Fourier Transform (FT) applied to the vibratory signal over a time window of short duration. This is referred to as a Short Time Fourier Transform (STFT) or a Sliding Window Fourier Transform (SWFT). The raw spectrogram 1100 is obtained by concatenating the spectra determined by STFT, for a plurality of successive time windows along the time axis. The time interval between two time windows is of a predefined duration. For example, the time interval may be shorter than the width of the time window, to allow at least partial overlap of the vibratory signal by two or more successive windows. The advantage of using such an FT is to have a sufficiently short time window to be able to consider that the vibratory signal, and therefore its spectral content, is stationary in this window even if the engine regime is in a transient or non-stationary phase.

From a mathematical point of view, the construction of the raw spectrogram 1100, during the first step 110, from the vibratory signal can be expressed as follows:

Consider the discrete vibro-acoustic signal x(t)_{{t=1, . . . , k}}, where t denotes the time sample and K is the signal length, as an addition:

$$x ( t ) = s ( t ) + v ( t ) . \qquad ( eq . 1 )$$

s(t) can be considered as a sum of sinusoids characterised by a power spectral density (PSD) with finite spectral masses and discrete frequencies. v(t) can be considered as a residual signal comprised of random components. For example, in the case of the vibratory signal, s(t) represents cyclic components produced by a rotating machine and v(t) represents the effects of noise, the source(s) of which may be fluid flow around and within the aircraft, turbulence or transient events related to the operation of the engine of the rotating machine.

Thus, the signal s(t) can be considered to contain the harmonic content of interest for the estimation of the instantaneous speed of rotation, and the families of harmonics of non-interest can be considered to be contained in the residual signal v(t). This leads to the following analytical expression:

$$x ( t ) = {\sum }_{p = 1}^{P} {A}_{p} ( t ) {e}^{j p ϕ ( t )} + v ( t ) . \qquad ( eq . 2 )$$

P is the harmonic order of the frequency content

ϕ(t)=∫₀^{t}f(s)ds is the instantaneous phase associated with the instantaneous frequency f(t) to be estimated. j is the imaginary number here.

Aₚ(t) is defined as the complex Fourier coefficients of each harmonic of index p. This last term can also be written:

$${A}_{p} ( t ) = {c}_{p} ( t ) {e}^{j {θ}_{p} ( t )} , \qquad ( eq . 3 )$$

where cₚ and θ_{P} are the p-th amplitude and the p-th phase of the p index amplitude.

The STFT can then be obtained by multiplying the vibratory signal x(t) by a sliding window w, along the time axis, to obtain a time segment of the vibratory signal, and then applying the FT to this time segment. The window w used can be any type of function conventionally used in signal processing. For example, it could be a Gaussian function, a Hamming function, a Hanning function, etc. Method 100 according to the invention is not restrictive as regards the windowing applied. Preferably, the window applied is chosen so as to minimise its impact on the harmonic content, for example to avoid artificially adding frequencies to the spectrogram and/or to avoid distorting the harmonic content of interest.

The STFT of the discrete vibratory signal x(t) into a discrete spectrum X(n, k) is then expressed by:

$$X ( n , k ) = {\sum }_{l = 0}^{L - 1} x ( l + n R ) w ( l ) {e}^{- j 2 π l k Δ f} , \qquad ( eq . 4 )$$

$$0 \leq l + n R < K , k = 0 , 1 , … , ⌈ \frac{1}{Δ} f ⌉ .$$

R is the size of the overlap between two temporally adjacent windows w(l), where l is the index of the temporal segment. Δ is the frequency step and L is the segment size. f is a frequency. n and k are indices of the time and frequency samples in the spectrogram, respectively.

After inserting equation (eq.2) into (eq.4), the expression for X(n, k) becomes:

$$X ( n , k ) = {\sum }_{l = 0}^{L - 1} {\sum }_{p = 1}^{P} {A}_{p} ( l + n R ) {e}^{j p ϕ ( l + n R )} w ( l ) {e}^{- j 2 π l k Δ f} + V ( n , k ) . \qquad ( eq . 5 )$$

V(n, k) is here the spectrum of noise and non-interesting frequencies contained in the signal v(t).

When constructing the raw spectrogram 1100, in the first step 110, the duration of a time segment can be considered to be small. Thus, the instantaneous frequency can be considered to be almost constant per time segment. This implies that f(l+nR)≈f(nR). The expression ϕ(l+nR) can then be approximated by:

$$ϕ ( l + n R ) \approx ϕ ( n R ) + 2 π \frac{f ( n R ) l}{{F}_{s}} , \qquad ( eq . 6 )$$

where F_{S} is the sampling frequency. The approximation

$$ϕ ( n R ) \approx 2 {πΣ}_{i = 1}^{n - 1} \frac{f ( n ) R}{{F}_{s}}$$

Similarly, for a time segment of short duration, the Fourier coefficients, i.e. amplitudes of the frequency content, can be considered constant over each segment. Therefore: Aₚ(l+nR)≈Aₚ(nR).

For simplicity, in the following, the term R will be omitted from the notation so that A_{p,n}, ϕₙ and fₙ refer to Aₚ(nR), ϕ(nR) and f(nR), respectively. The following expression is derived:

$$X ( n , k ) = {\sum }_{p = 1}^{P} {A}_{p n} {e}^{j p {ϕ}_{n}} {\sum }_{l = 0}^{L - 1} w ( l ) {e}^{- j 2 π l ( k Δ f - p {f}_{\{ n \}} )} + V ( n , k ) \qquad ( eq . 7 )$$

The expression can be defined

$${\sum }_{l = 0}^{L - 1} w ( l ) {e}^{- j 2 π l ( k Δ f - p {f}_{\{ n \}} )} = W ( k Δ f - p {f}_{n} ) \qquad ( eq . 8 )$$

as the Fourier transform of the window w. This amount is used to introduce the frequency resolution of the STFT or, equivalently, the filter bandwidth of the STFT. Thus, from the previous expressions, the following expression can be derived:

$$X ( n , k ) = {\sum }_{p = 1}^{P} {A}_{p n} {e}^{j p {ϕ}_{n}} W ( k Δ f - p {f}_{n} ) + V ( n , f ) = S ( n , k ) + V ( n , k ) . \qquad ( eq . 9 )$$

It can also be considered that Xₙ=[X(0, n), . . . , X(F−1, n)]^{T}, Vₙ=[V(0, n), . . . , V(F−1, n)]^{T} and Aₙ=[Aₙ, . . . , Aₚₙ]^{T}. It can also be considered H(fₙ)∈ [symbol] ^{F×P} as being H(fₙ)ₖₚ=e^{jpϕ(n)}(kΔf−pfₙ). Thus, the following expression is obtained:

$${X}_{n} = H ( {f}_{n} ) {A}_{n} + {V}_{n} , ∀ n ∈ \{ 1 , … , N \} , \qquad ( eq . 10 )$$

with

$$N = ⌊ \frac{K - ( L - R )}{R} ⌋ ,$$

the number of time segments.

The raw spectrogram 1100 constructed in step 110 of the method 100 according to the invention can thus be constructed according to the multi-harmonic model as defined in equation (eq.10), the multi-harmonic model being able to be represented as X=[X₀, . . . , Xₙ, . . . , X_{N-1}]^{T}.

The method 100 according to the invention comprises, after the first step 110 of constructing the raw spectrogram 1100, a second step 120 of denoising the raw spectrogram 1100. This step 120 makes it possible to obtain a denoised spectrogram which can be utilised without the risk of biasing determination of the engine speed due to the amplification of some frequency zones by the broadband noise which causes deviations in the trajectory or trajectories and which locally amplifies amplitudes in the raw spectrogram 1100.

Preferably, the second, denoising step 120 makes it possible to obtain an equalised spectrogram. By equalised spectrogram, it is meant a raw spectrogram 1100 whose noise has been standardised along the time dimension and along the frequency dimension of the spectrogram over all the time segments. This step makes it possible to improve emergence of the harmonic content of interest, which is representative of the signature of the shaft line wheels in relation to the noise. As a reminder, denoising in the Fourier domain is promoted because the noise can be considered to be decorrelated from the harmonic content of interest, unlike in the time domain.

The step 120 of denoising the raw spectrogram 1100 may be based on estimating a foot of the spectrum. By “foot of spectrum”, it is meant all the random harmonic components contained in the raw spectrogram 1100. This definition therefore includes all the effects of broadband noise, such as aerodynamic noise, combustion noise and resonance noise. From a graphical point of view, the foot of the spectrum is the line that passes through the broadband component in a smooth manner, as if the peaks were absent. The denoising step 120 can thus include a first sub-step 121 of estimating a foot of the spectrum of the raw spectrogram 1100. Subsequent to the first sub-step 121 of estimating a foot of the spectrum of the raw spectrogram 1100, the denoising step 120 may further comprise a second sub-step 122 of determining an equalised spectrogram. In the second sub-step 122, the equalised spectrogram may be determined from the division of the raw spectrogram 1100 by the foot of the spectrum of the raw spectrogram 1100. This may, for example, be a weighted division as a function of the frequency under consideration, or a simple division.

Furthermore, denoising, in the second step 120 of the method 100, can be carried out by estimating the foot of the spectrum for each time segment defined during calculation of the STFT. The estimate of the foot of the spectrum at the first sub-step 121 can then be an estimate per time segment of the foot of the spectrum.

Furthermore, denoising can be performed by dividing, for each time segment, the amplitudes in the raw spectrogram 1100 by the estimated foot of the spectrum. The equalised spectrogram determined in the second sub-step 122 may then be determined, for each time segment, from the division of the raw spectrogram 1100, of said time segment, by the foot of the spectrum of said time segment estimated in the first sub-step 121. The division may be a simple division or a weighted division, for example as a function of the frequencies of the spectrogram.

Mathematically, the implementation of the second step 120, for denoising the raw spectrogram 1100 from the estimate of the foot of the spectrum per time segment, can be translated as follows.

Firstly, for each time segment of the spectrogram of the vibratory signal Xₙ, the first sub-step 121 estimates the foot of the spectrum \hat{P}ₙ, with \hat{P}ₙ=[\hat{P}(0, n), . . . , \hat{P}(F−1, n)]^{T}.

It is possible to define the foot of the spectrum as

$$P ( k , n ) = {lim}_{L \to + ∞} 𝔼 \{ X ( k , n ) \}$$

when x(t) contains only random components. However, the vibratory signal x(t) comprises, in addition to the random components v(t), the deterministic part s(t) which contains the frequencies of interest of the vibratory signal. In such a case, there is no exact definition of the foot of the spectrum \hat{P}ₙ for the deterministic part of the signal. However, this foot of the spectrum of the deterministic part of the signal can be estimated from the trend of Xₙ, even if the latter contains peaks. This estimate for the deterministic part of the vibratory signal can be considered to be equivalent to performing a regression on the raw spectrogram 1100 Xₙ, so as to be robust with respect to peaks.

The first sub-step 121 of estimating the foot of the spectrum may thus comprise a first sub-sub-step 121a of constructing a regression function of the raw spectrogram 1100 Xₙ. Said regression function may be constructed per time segment and may, furthermore, be robust with respect to the peaks contained in the raw spectrogram 1100.

The regression at sub-sub-step 121a can be written as

$${X}_{n} = {g}_{n} + ϵ ( k ) . \qquad ( eq . 11 )$$

gₙ(·) is the regression function and ∈(·) is an approximation error of the regression.

The regression function gₙ of the first sub-sub-step 121a can be constructed from a trend estimation method. Preferably, the trend estimation method for constructing the regression function is time-efficient and simple in order to control curvature of the regression.

The regression function can, furthermore and preferably, be modelled using a heavy-tailed distribution of the error in order to take account of the impulsive nature of the noise in the raw spectrogram 1100. This takes into account the fact that vibratory signals in aeronautics are subject to multiple components. The use of a heavy-tailed error distribution also improves robustness of the regression against interference harmonics. Indeed, it is remembered that these vibratory signals generally comprise at least two families of harmonics, which are associated with two simultaneous asynchronous regimes N1 and N2. If the aim is to determine the instantaneous speed of N1, then N2 is considered to be a source of noise, in addition to the harmonics of no-interest associated with N1.

The regression function can be a spline regression function, with a flexible choice of error distribution E. The basis of the splines can be chosen to be numerically stable. In this case, it may be the B-spline basis, which then consists of the construction of a B-spline basis, in the first sub-sub-step 121a, of order o for a number of knots 0. The parameters for the order and number of knots are predetermined so as to enable the regularity of the regression function of the raw spectrogram 1100 Xₙ to be controlled and its edge effects to be reduced.

In order to make this regression robust, the regression function can also be applied to the logarithm of the raw spectrogram 1100 Xₙ, instead of being applied directly to the raw spectrogram 1100 Xₙ. Indeed, the logarithmic transformation homogenises amplitudes of the spectrum and is robust to peaks. Indeed, the distribution of the logarithm of Xₙ is more symmetrical than that of Xₙ.

Consequently, the regression of the raw spectrogram 1100 at sub-sub-step 121a can be written as follows:

$$ln {X}_{n} = {\sum }_{j = 1}^{O} {B}_{j} {c}_{j} ( k ) + ϵ ( k ) . \qquad ( eq . 12 )$$

B is the B-spline basis and {cⱼ; j=1, . . . , 0} are coefficients of the B-spline basis B. The B-spline basis can be constructed via a conventional method in the literature.

The distribution of the regression error ∈(k) makes the regression more robust to peaks. Herein, this distribution of the error ∈(k) can be heavy-tailed in order to take the existence of peaks in Xₙ into account. For example, this distribution of the error ∈(k) can follow a Student's law. A maximum likelihood can then be determined according to the Student's law model using, for example, an Iteratively Reweighted Least Squares (IRLS) algorithm. This algorithm estimates error weights by optimising an objective function where the error itself depends on the weights of the objective function. At each iteration of the IRLS algorithm, values of samples whose error is greater than a predefined threshold can be truncated. This provides greater robustness with respect to peaks. Said predefined threshold can be, for example, a constant multiplied by the median of the absolute value of the error. Furthermore, the IRLS algorithm makes it possible to obtain the coefficients c of the B-spline basis.

The first sub-step 121 of estimating the foot of the spectrum may further include a second sub-sub-step 121b of determining the foot of the spectrum from the regression function.

Given estimated values {c_{min,j}; j=1, . . . , 0}, the determination of the foot of the spectrum P, at the second sub-sub-step 121b may be given by:

$${\hat{P}}_{n} = {e}^{{\sum }_{j = 1}^{O} {B}_{j} {c}_{min , j} ( k )} . \qquad ( eq . 13 )$$

FIG. 4 shows an example application of the first sub-step 121 of estimating a foot 1220 of a spectrum 1210 of a signal. The signal used here is a noisy vibratory signal, representative of a vibratory signature of an aircraft engine and containing a plurality of peaks. Following the sub-sub-steps 121a and 121b of regressing the spectrum 1210 and determining the foot 1220 of the spectrum 1210, a regression function robust to the peaks of the logarithm of the spectrum 1210 is first constructed, and then the foot 1220 of the spectrum 1210 is determined.

It can thus be observed that the estimation of the foot of the spectrum 1220 is, in fact, robust with respect to the peaks: it follows the trend of the spectrum 1210 without being affected by the peaks in the vicinity. It may also be noted that estimating the foot of the spectrum 1220 can be likened to determining the spectral density of the noise in the spectrum 1210.

The determination of an equalised spectrogram 1200 Yₙ per time segment, i.e. a spectrogram whose noise is uniform along the time and frequency axes, can then be achieved, in the second sub-step 122, by dividing the spectrum Xₙ as a function of the foot of the spectrum \hat{P}ₙ such that:

$${Y}_{n} = \frac{{X}_{n}}{{\hat{P}}_{n}} , n ∈ [ 1 , N ] . \qquad ( eq . 14 )$$

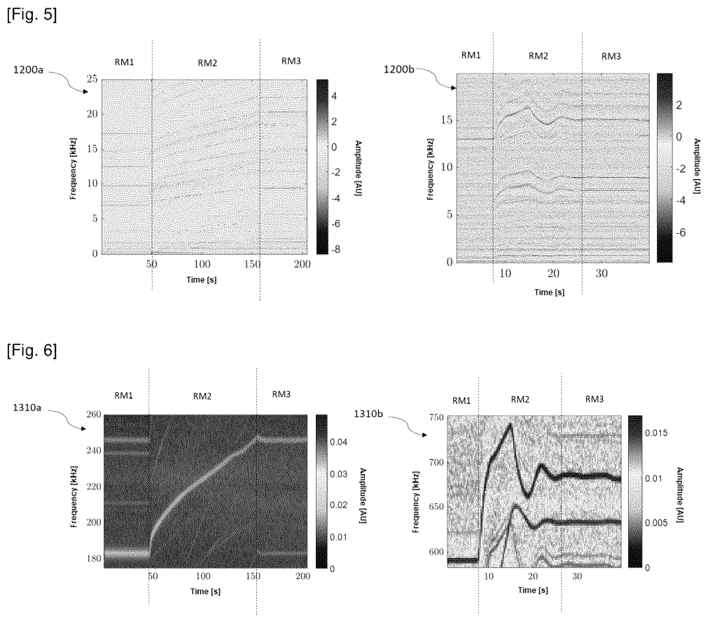

To illustrate the effect of denoising by equalising a spectrogram, FIG. 5 shows two equalised spectrograms 1200a and 1200b. The equalised spectrograms 1200a and 1200b result from the denoising processing according to the second step 120 of the method 100 of the raw spectrograms 1100a and 1100b, respectively, of FIG. 3. It is reminded that spectrogram 1100a results from the vibratory signal acquired for the aeroplane engine and that spectrogram 1100b results from the vibratory signal acquired for the helicopter engine. From these two examples, it can be observed that the equalised spectrograms 1200a and 1200b are denoised from the broadband noise contained in the raw spectrograms 1100a and 1100b. Furthermore, the frequencies of interest are more clearly apparent from the background noise. The denoising step 120 is therefore very robust to the peaks contained in the raw spectrograms 1100a and 1100b; this robustness is, moreover, essential for implementing the method 100 according to the invention, in view of the abundance of spectral peaks, generated by the different rotating members, in aircraft vibratory signals.

Advantageously, the step 120 of denoising by equalising the spectrogram by time segments provided makes it possible not only to attenuate background noise, but also to attenuate quasi-stationary components of the time-frequency plane, in the case where the component sought is highly non-stationary (speed rise, speed fall), and conversely to attenuate non-stationary components, in the case where the component sought is quasi-stationary.

The method 100 according to the invention also includes a third step 130 of separating sources. By source separation, it is meant the discrimination of two or more signal sources, herein vibratory signals, present in a same signal. Preferably, source separation serves to differentiate the harmonic content of interest masked by harmonic content of non-interest, caused by harmonic interference, from the various noise sources, which may coexist, intersect, be very close, or even merge, in a same frequency band. This step therefore reduces sensitivity of the equalised spectrogram 1200 to harmonic interference. Thus, it is possible to follow the trajectory or trajectories 1310 and their evolution. It is remembered that the different mechanical elements in the shaft line, which are all sources of the harmonics of interest, are identifiable in the spectrogram as trajectories that vary as a function of the instantaneous speed. The engine speed, especially the instantaneous speed of rotation, is determined as a function of these trajectories.

The third step 130 is preferably a step of determining an estimator of the frequencies of interest. The estimator of the frequencies of interest is representative of the harmonic content of interest of the equalised spectrogram 1200. The estimator of the frequencies of interest is, for example, determined as a function of restrictions applied to the trajectories 1310 observed in the equalised spectrogram 1200. This may, among other things, be restrictions relating to the frequency of the trajectory or trajectories 1310, and/or restrictions on the amplitude of these frequencies. Indeed, the engine speed, especially its instantaneous speed of rotation, can be determined by following the maximum amplitude in a given frequency band. It is therefore necessary to ensure that the maximum amplitude is associated with the instantaneous speed of rotation to be determined, at the risk of deviating from the correct trajectory and therefore providing an erroneous estimate of the instantaneous frequency.

The restrictions on the trajectories 1310 may also relate to the regularity of the trajectories. The regularity may, for example, define a regularity in the evolution of the trajectory or trajectories 1310 and/or the associated amplitudes. The regularity of the trajectories 1310 may also be defined as a function of one or more predefined frequency bands. These may, for example, be frequency bands otherwise known as a function of the dimensioning of the shaft line.

The use of such regularity restrictions also makes it possible to avoid jumps and discontinuities in the trajectories 1310, for example due to the presence of isolated peaks of residual noise after the denoising step 120.

The estimator of the frequencies of interest can, furthermore, be determined as a function of one or more frequencies of interest in the equalised spectrogram 1200 and the associated amplitudes. Preferably, the estimator of the frequencies of interest is determined as a function of a distribution of the harmonic content of interest of the equalised spectrogram 1200. The estimator of the frequencies of interest may, for example, be determined by maximising distribution of the frequencies of interest in the equalised spectrogram 1200.

As mentioned previously, it is possible to follow several trajectories 1310 simultaneously. The advantage of taking several harmonics into account instead of just one is that it is possible, for example, to weight different trajectories and their harmonics in relation to each other. As a result, it is possible to give more weight to trajectories considered to be close to the desired instantaneous frequency, and to reduce sensitivity of the harmonic content of interest to harmonic interference, for example to moments of coupling between different components. The harmonics monitored are, for example, predetermined as a function of the dimensioning of the shaft line. They may also be the most energetic harmonics, known as a function of the dimensioning of the rotating elements of the engine, which makes it possible to avoid deviations due to one or more energetic interference components.

This multi-component approach is made possible by the fact that the vibratory signal is processed in the spectral domain. The hypothesis that the harmonics of interest and the harmonics of non-interest are decorrelated is in fact sufficiently robust in the spectral domain to allow only part of the harmonics of the vibratory signal to be used, rather than all of them as would be necessary in the time domain. This hypothesis of decorrelation is all the more advantageous as aeronautical vibratory signals are very rich in harmonic content, and taking all these harmonics into account would be inextricable.

When the multi-harmonic model set forth in equation (eq.10) is considered, only the raw spectrogram Xₙ 1100 of the vibro-acoustic signal is known. In particular, the amplitudes Aₙ of the frequency content of interest are not known. However, to estimate the frequencies of interest fₙ, and thus determine the instantaneous engine speed, it is necessary to know the amplitudes Aₙ. Indeed, the instantaneous speed of rotation can be identified as a function of the amplitude of the different trajectories, preferably according to the trajectory with the highest amplitude. The third, source separation step 130 is therefore a step for identifying the frequencies of interest fₙ in the harmonic content from an estimate of the amplitudes Aₙ of the harmonic content of interest by estimating an estimator of the frequencies of interest. This estimator of the frequencies of interest therefore makes it possible to discriminate the frequencies of interest fₙ from the effects of harmonic interference.

The estimator of the frequencies of interest can be determined using an iterative search algorithm. For example, this could be an algorithm based on the minimisation of a cost function, such as a multi-objective gradient method or a genetic algorithm. It is also possible to use a method based on the Bayesian theory.

The iterative search algorithm is preferably an Expectation-Maximisation (EM) algorithm. Because of its Bayesian approach, such an algorithm makes it possible to introduce regularity and continuity restrictions during estimation. This reduces the risk of deviation in the estimation of trajectories 1310. The EM algorithm is used to obtain an a posteriori probability distribution for the frequency. The estimator of the frequencies of interest can further be determined as a function of the a posteriori probability law on the frequency.

The EM algorithm comprises two alternately iterated steps: an E-step or expectation step, and an M-step or maximisation step. Preferentially, the third source separation step 130 therefore comprises two sub-steps 131 and 132, corresponding to the E-step and M-step of the EM algorithm, which are alternately repeated until a predefined convergence criterion is satisfied. Step 130 is therefore an alternative iteration of sub-steps 131 and 132.

The first sub-step 131, or E-step, is a step of estimating the frequencies of interest fₙ from the amplitudes Aₙ of the harmonic content of interest. The second sub-step 132, or M-step, is a step of estimating the amplitudes Aₙ as a function of the values of the frequencies fₙ, determined in the previously performed sub-step 131.

The predefined convergence criterion is preferably a criterion defined so that the final error on the estimation of the frequencies of interest fₙ and the amplitudes Aₙ of the frequencies of interest is sufficiently small, for example below a predefined error threshold. The convergence criterion may, for example, be the predefined error threshold to be reached or a maximum number of iterations of step 130 to be performed.

It is reminded that the spectral content Vₙ of the noise is modelled by a heavy-tailed distribution to take the multi-harmonic nature of the harmonic content of non-interest into account. Preferably, the spectral content V(n, f), n E {1, . . . , N} and k∈{0, . . . , F−1} is considered to be independent and identically distributed according to a Smoothed Generalized Gaussian (SGG) distribution. This SGG distribution can be such that:

$$g ( z ; β , δ , σ ) = C ( σ , δ , β ) {e}^{- {( \frac{{\vert z \vert}^{2}}{{σ}^{2}} + δ )}^{\frac{β}{2}}} , \qquad ( eq . 15 )$$

where β>0 is a shape parameter, σ>0 is a shape factor (also known as the variance of the SGG distribution), δ>0 is a constant and C(σ, δ, β) is a normalisation constant.

The interest of using a SGG, as opposed to a generalised Gaussian (GG) distribution, is that the constant δ, not present in the GG, generally takes small values, for example δ=10⁻⁴), which allows the SGG to have a behaviour similar to that of a Gaussian around 0 and makes it possible to retain a robust statistic. In addition, the parameter δ allows the probability density to be differentiable at the origin, allowing gradient-based methods to be used more efficiently.

The shape parameter β is representative of the impulsive nature of the spectral noise. The shape parameter β is preferably chosen to have a value between 0 and 2, to retain mathematical properties of a Gaussian distribution. To avoid any divergence due to convexity, the shape parameter β is chosen so as not to be too small. Preferably, this parameter is greater than 0.1.

It is also reminded that the frequencies of interest fₙ are discrete variables. They can take values from a possible set of frequencies [symbol] of cardinal B. For example, [symbol] can be the entire frequency axis of the STFT, in which case B=F, or just a subset of the frequency axis, in which case B<F, if the minimum and maximum bounds of the frequencies of interest fₙ are known. It is thus possible to write a log-likelihood l(·) where the frequencies of interest fₙ are marginalised from a joint distribution:

$$\begin{matrix}l ( {A}_{n} ; {Y}_{n} ) & = & - log p ( {Y}_{n} \vert {A}_{n} ) \\ l ( {A}_{n} ; {Y}_{n} ) & = & - log {\sum }_{{v}_{k} ∈ ℱ} p ( {Y}_{n} , {f}_{n} = {v}_{k} \vert {A}_{n} ) \\ l ( {A}_{n} ; {Y}_{n} ) & = & - {\sum }_{{v}_{k} ∈ ℱ} \partial ( {f}_{n} - {v}_{k} ) {\sum }_{f = I}^{F} log g ( {[ {Y}_{n} - H ( {v}_{k} ) {A}_{n} ]}_{f} ; β , δ , σ )\end{matrix} , \qquad ( eq . 16 )$$

where vₖ represents the values that the frequency fₙ can take in the frequency set [symbol] and ∂(·) is the Kronecker delta.

In equation (eq.16), the logarithm is applied to a sum of densities. The sum within the logarithm therefore prevents application of the logarithm directly to the joint probability p(Yₙ, fₙ=vₖ|Aₙ). This results in a complicated expression for the solution of the a posteriori maximum. However, for a given frequency of interest fₙ, given the negative log-likelihood function of {Yₙ, fₙ} given by −log p(Yₙ, fₙ|Aₙ), an estimator of the amplitude Aₙ of the frequency of interest fₙ can be estimated from an posteriori distribution Ân of the amplitude after the observations Yₙ are obtained. This is equivalent to minimising the negative logarithm of the a posteriori probability given by:

$$\begin{matrix}G ( {A}_{n} \vert {Y}_{n} , {f}_{n} ) & = & - log p ( {A}_{n} \vert {Y}_{n} , {f}_{n} ) \\ G ( {A}_{n} \vert {Y}_{n} , {f}_{n} ) & = & l ( {A}_{n} ; {Y}_{n} ) - log p ( {A}_{n} )\end{matrix} , \qquad ( eq . 17 )$$

where G(Aₙ|Yₙ, fₙ) is the a posteriori probability considered after the observations Yₙ have been obtained. p(Aₙ). The a posteriori probability represents the hypotheses made about the amplitudes Aₙ. The log-likelihood l(Aₙ; Yₙ) expresses how likely it is that the observations Yₙ can be related to the parameter Aₙ.

When the frequencies fₙ are observed, the minimisation of (16) is straightforward. However, only the observations Yₙ are known because fₙ is not observable in the case of a vibratory signal of an aircraft engine. Instead, an a priori law pₖ(n) on the frequency distribution fₙ is observable at each time step n: p₁(n), . . . , p_{B}(n). It gives the a priori probability that the frequencies fₙ take the values v₁, . . . , v_{B} in [symbol] , respectively.

This type of solution to a problem with unobservable parameters is made possible by virtue of the use of an algorithm such as the EM algorithm. The algorithm thus aims to obtain the a posteriori probability maximum (APM) estimators from the observations. In the EM algorithm, the frequencies of interest fₙ are a hidden variable, i.e. a variable used to estimate the amplitudes Aₙ. This choice is motivated by the ease of calculating the log-likelihood expectation for discrete variables. Indeed, the frequencies of interest fₙ have discrete values, whereas the amplitudes Aₙ have continuous values.

Mathematically, the EM algorithm can be reflected as follows.

The expectation step or E-step, also sub-step 131 of the method 100 according to the invention, may include a first sub-sub-step 131a of determining an a posteriori probability zₖ(n)⁽ⁱ⁺¹⁾ on the frequencies of interest fₙ. This first sub-sub-step 131a then makes it possible, in a second sub-sub-step 131b, to determine an expectation Q⁽ⁱ⁺¹⁾(Aₙ, Aₙ⁽ⁱ⁾) of the log-likelihood l(Aₙ; Yₙ) from equation (eq.16). The expectation Q⁽ⁱ⁺¹⁾(Aₙ, Aₙ⁽ⁱ⁾) of the log-likelihood can, furthermore, be determined from a conditional distribution p(fₙ|Yₙ, Aₙ⁽ⁱ⁾) of the frequencies of interest fₙ, given observed data Yₙ, and given a current estimate of the amplitudes Aₙ⁽ⁱ⁾. The index i indicates the number of the current iteration of the EM algorithm.

In the first sub-sub-step 131a, the a posteriori probability zₖ(n)(i+1) can be defined by:

$$\begin{matrix}{z}_{k} {( n )}^{( i + 1 )} & = & 𝔼 [ {f}_{n} \vert {Y}_{n} , {A}_{n}^{( i )} ] \\ {z}_{k} {( n )}^{( i + 1 )} & = & {p}^{( i + 1 )} ( {f}_{n} = {v}_{k} \vert {Y}_{n} , {A}_{n}^{( i )} )\end{matrix} . \qquad ( eq . 18 )$$

Using Bayes' formula, the a posteriori probability zₖ(n)⁽ⁱ⁺¹⁾ from equation (eq.18) can be written as:

$$\begin{matrix}{z}_{k} {( n )}^{( i + 1 )} & = & \frac{{p}^{( i + 1 )} ( {Y}_{n} \vert {f}_{n} = {v}_{k} , {A}_{n}^{( i )} ) {p}^{( i + 1 )} ( {f}_{n} = {v}_{k} \vert {A}_{n}^{( i )} , {Y}_{n} )}{{p}^{( i + 1 )} ( {Y}_{n} , {A}_{n}^{( i )} )} \\ {z}_{k} {( n )}^{( i + 1 )} & = & \frac{{p}_{k} ( n ) {\prod }_{f = 1}^{F} g ( {[ {Y}_{n} - H ( {v}_{k} ) {A}_{n}^{( i )} ]}_{f} ; β , δ , σ )}{{\sum }_{k} {p}_{k} ( n ) {\prod }_{f = 1}^{F} g ( {[ {Y}_{n} - H ( {v}_{k} ) {A}_{n}^{( i )} ]}_{f} ; β , δ , σ )}\end{matrix} . \qquad ( eq . 19 )$$

The a priori law pₖ(n) on the frequency distribution can be initialised as a function of known values of the frequencies of interest in the spectrogram. These values may be known, for example, by virtue of a dimensional analysis of the shaft line of the aircraft engine. The aim is to provide a priori information about the frequencies of interest on fₙ. These values can, for example, be minimum fₘᵢₙ and maximum fₘₐₓ values, or values around a harmonic ([k fₘᵢₙ, k fₘₐₓ]).

pₖ(n) can then be updated from time instant n to time instant n+1 by taking previous estimates of the frequencies of interest fₙ into account and using a marginal distribution. Among other things, the marginal distribution can be obtained by integrating previous estimates of the frequencies of interest fₙ into a joint distribution p(fₙ, . . . , f_{n-M}), in a given window of size M.

The joint distribution p(fₙ) can be obtained using a priori knowledge of the continuity of the frequency curve. Assuming M=1, the joint distribution becomes p(fₙ)= [symbol] q(fₙ|fₙ₋₁=vₖ; ε²)zₖ(n−1), where q(·|fₙ₋₁=vₖ; ε²) is a Gaussian density of mean vₖ and variance ε². This is equivalent to convolving the previous conditional densities p(fₙ₋₁|Aₙ₋₁, Yₙ₋₁) with a Gaussian kernel. It is reminded that vₖ represents the values that the frequency fₙ can take in the set of frequencies F.

Two examples of a posteriori probability distributions zₖ on the frequency are set forth in FIG. 6. These a posteriori probability laws zₖ are obtained from the equalised spectrograms 1200 of FIG. 6. The a posteriori probability law 1310a is obtained from the equalised spectrogram 1200a of the application with the aeroplane engine. The a posteriori probability law 1310b is obtained from the equalised spectrogram 1200b of the application with the helicopter engine. This figure highlights that, depending on the choice of the shape parameter β, the a priori law pₖ(n) guarantees continuity of the frequency curve and harmonic orders between time instants, and the trajectory of interest can become the most energetic trajectory in the spectrogram.

From this a posteriori probability distribution zₖ, it is possible to determine one or more point estimators to estimate the instantaneous frequency f. For example, a point estimator of the instantaneous frequency \hat{f}ₙⁱ⁺¹ may be the value which maximises the a posteriori probability zₖ(n)⁽ⁱ⁺¹⁾.

During sub-step 131, the expectation Q⁽ⁱ⁺¹⁾(Aₙ, Aₙ⁽ⁱ⁾) of the negative log-likelihood −log(fₙ|Yₙ, Aₙ) can, for example, be written with respect to the a posteriori probability p(fₙ=vₖ|Yₙ, Aₙ⁽ⁱ⁾). The expectation of the negative log-likelihood −log(fₙ|Yₙ, Aₙ) can be given by:

$$\begin{matrix}{Q}^{( i + 1 )} ( {A}_{n} , {A}_{n}^{( i )} ) & = & {𝔼}_{p ( {f}_{n} = {v}_{k} \vert {Y}_{n} , {A}_{n}^{( i )} )} [ log p ( {Y}_{n} , {f}_{n} = {v}_{k} \vert {A}_{n} ] \\ {Q}^{( i + 1 )} ( {A}_{n} , {A}_{n}^{( i )} ) & = & - {\sum }_{{v}_{k} ∈ ℱ} p ( {f}_{n} = {v}_{k} \vert {Y}_{n} , {A}_{n}^{( i )} ) log p ( {Y}_{n} , {f}_{n} = {v}_{k} \vert {A}_{n} ) \\ {Q}^{( i + 1 )} ( {A}_{n} , {A}_{n}^{( i )} ) & = & - {\sum }_{{v}_{k} ∈ ℱ} {{z}_{k} ( n )}^{( i + 1 )} {\sum }_{f = 1}^{F} log g ( {[ {Y}_{n} - H ( {v}_{k} ) {A}_{n}^{( i )} ]}_{f} ; β , δ , σ )\end{matrix} . \qquad ( eq . 20 )$$

The a posteriori probability zₖ(n)⁽ⁱ⁺¹⁾ and the expectation Q⁽ⁱ⁺¹⁾(Aₙ, Aₙ⁽ⁱ⁾) of the log-likelihood can then be used in the M-step to determine the amplitudes Aₙ of the frequencies of interest.

The maximisation step or M-step, also sub-step 132 of method 100 according to the invention, is used to determine values of the amplitudes Aₙ.

During the maximisation step, amplitudes Aₙ can be determined by finding the argument that maximises its joint density or, equivalently, minimises its negative logarithm:

$${A}_{n}^{( i + 1 )} = arg {min}_{{A}_{n} ∈ {ℂ}^{P}} {G}^{( i + 1 )} ( {A}_{n} \vert {Y}_{n} ) . \qquad ( eq . 21 )$$

During a first sub-sub-step 132a, an a posteriori probability G⁽ⁱ⁺¹⁾(Aₙ|Yₙ) on the amplitude is determined. For example, the a posteriori probability G⁽ⁱ⁺¹⁾(Aₙ|Yₙ) is determined by:

$${G}^{( i + 1 )} ( {A}_{n} \vert {Y}_{n} ) = {Q}^{( i + 1 )} ( {A}_{n} , {A}_{n}^{( i )} ) - log p ( {A}_{n} ) . \qquad ( eq . 22 )$$

The a priori distribution p(Aₙ) for the unknown amplitudes Aₙ, can follow a predefined model. Preferably, the evolution of the amplitudes Aₙ follows an autoregressive model taking old measurements into account, which makes it possible to restrict regularity of the amplitudes Aₙ of the trajectories. For example, the predefined model can be a linear model such that Aₙ=αAₙ₋₁+∈ₙ, where ∈ₙ follows a complex circular Gaussian distribution, with a is a known constant such that 1≥α>0. Alternatively, the predefined model can be a non-linear model.

Solving equation (eq.21) in step 132, to determine the amplitudes Aₙ, may further be included during a second sub-sub-step 132b. This second sub-sub-step 132b makes it possible, for example by means of an iterative algorithm, to determine the a posteriori probability G⁽ⁱ⁺¹⁾(Aₙ|Yₙ). Furthermore, since the a posteriori probability G⁽ⁱ⁺¹⁾(Aₙ|Yₙ) is differentiable and convex for § 1, it is possible to use an iterative algorithm based on gradient estimation. For example, it is possible to use a majorize-minimization (MM) algorithm.

Sub-step 132 may then comprise a sub-sub-step 132c of updating the form factor σ, or variance, of the SGG distribution of the noise. Updating can be performed by estimating a maximum likelihood of the shape factor σ of the noise distribution, from equation (eq.17). The maximum likelihood estimate can, for example, be formulated as

$${σ}_{( q + 1 )}^{( i + 1 )} = {arg min}_{∈ σ ℝ} {G}^{( i + 1 )} ( {A}_{n} = {A}_{n ( q )}^{( i + 1 )} \vert {Y}_{n} ) . \qquad ( eq . 23 )$$

At iteration q+1 of the MM algorithm and i+1 of the EM algorithm, once the a posteriori probability gradient G(A_{n(q)}⁽ⁱ⁾) is estimated, an estimate of a can be given by:

$${σ}_{( q + 1 )}^{( i + 1 )} = {( \frac{β {\sum }_{{v}_{k} ∈ ℱ} {\sum }_{f = 1}^{F} {[ {Y}_{n} - {H ( {v}_{k} )}_{( q )} {A}_{n ( q )}^{( i + 1 )} ]}_{f}^{β}}{2 F {\sum }_{{v}_{k} ∈ ℱ} {{z}_{k} ( n )}^{( i + 1 )}} )}^{\frac{1}{β}} . \qquad ( eq . 24 )$$

The amplitudes Aₙ and variance σ_{(q+1)}⁽ⁱ⁺¹⁾ of the SGG distribution can then be used in a further iteration of the EM algorithm to determine the a posteriori probability zₖ(n) over the frequencies of interest.

At the end of step 130, after the convergence criterion of the EM algorithm is satisfied, the estimator of the frequencies of interest determined is, for example, the a posteriori probability zₖ(n), for all time instants n, determined at the last iteration of sub-step 131.

Finally, the method 100 according to the invention comprises a fourth step 140 of determining the instantaneous speed of rotation of the aircraft engine. The instantaneous speed of rotation is preferably estimated as a function of the estimator of the frequencies of interest. Advantageously, the instantaneous speed of rotation is estimated using the regression function whose error follows the heavy-tailed distribution, which makes it possible to demodulate said instantaneous speed of rotation simultaneously from several harmonics. The robustness of the estimate is therefore greatly improved with respect to deviations caused by other harmonics of non-interest.

The instantaneous speed of rotation can be determined as a function of part of the estimator of the frequencies of interest. For example, in the case where the estimator of the frequencies of interest is the a posteriori probability zₖ(n), for all time instants n, the instantaneous frequency can be determined as a function of the maximum of the estimator of the frequencies of interest. The maximum of the estimator of the frequencies of interest is in particular adapted to the case where there are several local maxima to be discriminated among the frequencies of interest.

Alternatively, rather than the maximum of the estimator, it is possible to use its mean, giving a smoother estimate of the frequency of interest.

The instantaneous frequency \hat{f}ₙ can, at each time instant n, be determined by:

$${\hat{f}}_{n} = {arg max}_{{v}_{k} ∈ ℱ} {z ( n )}^{( I )} . \qquad ( eq . 25 )$$

As the instantaneous frequency \hat{f}ₙ is determined for time instants n, the method 100 according to the invention may include a fifth step 150 of interpolating the values of the instantaneous frequency \hat{f}ₙ. This interpolation makes it possible to obtain a signal of the same length as the discrete vibratory signal x(n). The interpolation may, for example, be performed by spline type interpolation.

The method 100 according to the invention may further include a sixth step 160 of smoothing interpolation of the values of the instantaneous frequency \hat{f}ₙ. This smoothing makes it possible to attenuate the step-like effect induced by the frequency resolution.

It is then possible to plot a corrected spectrogram 1300, like the spectrograms 1300a and 1300b of FIG. 2, wherein the trajectories 1310 are clearly visible. The trajectory 1310 of the greatest amplitude is thus the trajectory of the instantaneous speed of rotation of the aircraft engine.

The method 100 according to the invention may additionally include a seventh step 170 of detecting an operating anomaly of the aircraft engine. Preferably, this detection is carried out as a function of the instantaneous speed of rotation, or of the associated trajectory 1310, determined in one of steps 140 to 160.

The operating anomaly is detected, for example, by comparing the instantaneous speed of rotation, or the associated trajectory 1310, with a reference speed of rotation, or data on a reference trajectory 1310. The detection may, furthermore, inform of the presence of an anomaly by means of an alert issued. The detection may, for example, be issued when a significant deviation is determined between the determined instantaneous speed of rotation and the reference instantaneous speed of rotation. This deviation is, for example, significant when it is greater than some predefined normal operating threshold, which may be known by means of a dimensional analysis of the shaft line of the aircraft engine.

1. A method for monitoring the engine speed of a rotating machine, the method comprising:
constructing a raw spectrogram from a vibratory signal measured by a vibration sensor;
denoising the raw spectrogram to obtain an equalised spectrogram, the denoising step comprising:
a first sub-step of determining a foot of the raw spectrogram, the foot of the spectrum being a set of random harmonic components contained in the raw spectrogram, the first sub-step comprising:
a first sub-sub-step of constructing a regression function robust to the peaks of the raw spectrogram, the regression function being applied to a logarithm of the raw spectrogram or to the raw spectrogram;
a second sub-sub-step of determining the foot of the spectrum from the regression function;
a second sub-step of determining the equalised spectrogram from the foot of the spectrogram;
separating sources in the equalised spectrogram by determining an estimator of the frequencies of interest;
determining an instantaneous speed of rotation of the engine speed from the estimator of the frequencies of interest.

2. The method for monitoring the engine speed of a rotating machine according to claim 1, further comprising detecting an operating anomaly of the engine of the rotating machine as a function of the instantaneous speed of rotation.

3. The method for monitoring the engine speed of a rotating machine according to claim 2, wherein the raw spectrogram is constructed by a Fourier Transform applied to the vibratory signal over a plurality of successive time windows of short duration.

4. The method according to claim 1, wherein the separating is repeated until a convergence criterion is satisfied, said separating comprising a first sub-step of determining frequencies of interest as a function of amplitudes of the frequencies of interest, and a second sub-step of estimating the amplitudes of the frequencies of interest as a function of the frequencies of interest, said first and second sub-steps being alternately performed at each iteration of said source separation step, and the estimator of the frequencies of interest being further determined as a function of the frequencies of interest and the amplitudes of the frequencies of interest.

5. The method according to claim 4, wherein the separating is implemented by an Expectation-Maximization algorithm, wherein the first sub-step of determining frequencies of interest is the E-step of the Expectation-Maximization algorithm, and wherein the second sub-step of estimating amplitudes of the frequencies of interest is the M-step of the Expectation-Maximization algorithm.

6. The method according to claim 4, wherein the sub-step of determining frequencies of interest as a function of amplitudes of the frequencies of interest comprises a first sub-sub-step of determining an a posteriori probability on the frequencies of interest, and a second sub-sub-step of determining an expectation of a log-likelihood of the amplitudes of the frequencies of interest.

7. The method according to claim 4, wherein the sub-step of estimating the amplitudes of the frequencies of interest as a function of the frequencies of interest comprises a first sub-sub-step of determining an a posteriori probability on amplitudes of the frequencies of interest, a second sub-sub-step of determining an a posteriori probability on amplitudes of the frequencies of interest, and a third sub-sub-step of determining a variance of a smoothed generalised Gaussian distribution of the equalised spectrogram.

8. The method according to claim 1, wherein the estimator of the frequencies of interest is determined, as a stopping criterion is satisfied, as a function of the a posteriori probability on the frequencies of interest.

9. The method according to claim 1, further comprising interpolating the estimator of the frequencies of interest.

10. The method according to claim 9, further comprising smoothing the interpolation of the estimator of the frequencies of interest.
